(19) United States
(12) Patent Application Publication
(10) Pub. No.: US 2026/0351493 A1
(43) Pub. Date: Nov. 5, 2026

(54) INSULATING FILM FOR A TEMPERATURE-DEPENDENT SWITCH, AND TEMPERATURE-DEPENDENT SWITCH

(71) Applicant: Marcel P. Hofsaess, Steintahleben (DE)

(72) Inventor: Marcel P. Hofsaess, Steintahleben (DE)

(21) Appl. No.: 19/660,158

(22) Filed: Apr. 27, 2026

(30) Foreign Application Priority Data
May 2, 2025 (DE) 10 2025 116 899.7

(51) Int. Cl. H01H 9/04; H01H 37/54

(52) U.S. Cl. CPC H01H 9/04; H01H 37/5427; H01H 2037/5472

(57) ABSTRACT

An insulating film for electrical insulation and/or for the mechanical sealing of a temperature-dependent switch. The insulating film is made of an electrically insulating material and has a through-hole which extends between an upper side of the insulating film and a bottom side of the insulating film opposite the upper side. Furthermore, the insulating film has at least one irregularity element for forming a local irregularity on the upper side and/or the bottom side. The at least one irregularity element exhibits a corrugation, local roughening and/or a local elevation.

### CROSS-REFERENCE TO RELATED APPLICATIONS

This application claims priority from German patent application DE 10 2025 116 899.7 filed May 2, 2025. The entire content of this priority application is incorporated herein by reference.

### FIELD

This disclosure relates to an insulating film for the electrical insulation and/or for the mechanical sealing of a temperature-dependent switch. Furthermore, the disclosure relates to a temperature-dependent switch in which such an insulating film is used.

An exemplary temperature-dependent switch is disclosed in DE 10 2013 101 392 A1.

Such temperature-dependent switches serve, in a manner known in the art, to monitor the temperature of a device. For this purpose, the switch is brought into thermal contact with the device to be protected, for example via one of the outer surfaces of said switch, such that the temperature of the device to be protected influences the temperature of the switching mechanism arranged inside the switch.

The switch is typically connected electrically in series into the power supply circuit of the device to be protected via connection leads, so that below the response temperature of the switch, the supply current of the device to be protected flows through the switch.

The temperature-dependent switching mechanism located inside the switch ensures the temperature-dependent switching behavior of the switch. In the closed switch state, the switching mechanism presses a movable contact part against at least one static mating contact, and thus establishes an electrical connection between the two outer terminals of the switch. In contrast, in the open switch state the switching mechanism holds the movable contact part at a distance from the at least one static mating contact, so that the electrical connection between the two outer terminals of the switch is disconnected.

The switching behavior, i.e., the switching between the closed switch state and the open switch state, takes place in a temperature-dependent manner. The temperature-dependent switching behavior of the switching mechanism is typically achieved by a bimetal element, which, in a known manner, switches or snaps between two configurations—a low-temperature configuration or low-temperature position and a high-temperature configuration or high-temperature position—depending on the temperature, in the manner of a hysteresis.

Thus, if the temperature of the bimetal element increases as a result of a temperature increase in the device to be protected above a defined temperature, which is referred to as the response temperature or switching temperature of the bimetal element, then the bimetal element snaps from its low-temperature configuration into its high-temperature configuration and thus causes a switching operation from the closed switch state to the open switch state or vice versa. In this case, depending on the installation type, the switch can be designed such that below the response or switching temperature it is in the closed switch state, which is referred to as “normally closed,” or instead in the open switch state, which is typically referred to as “normally open.”

The temperature-dependent switching mechanism is typically housed in a switch housing in such switches. Since the components of such a temperature-dependent switching mechanism are comparatively fragile, the switching mechanism is usually encapsulated in the switch housing to protect it from outer influences. The switch housing should be well sealed to prevent, for example, liquids or contaminants from entering the interior of the switch housing, which could lead to damage to the temperature-dependent switching mechanism.

Since most switch housings are made up of two parts, consisting of a lower part and a cover part that closes off the lower part, it is important to adequately seal the switch housing at the interface between the lower part and the cover part. For the purpose of this sealing, an insulating film is often used.

Such insulating films are used in these types of switches, in particular, when the components of the switch housing are current-carrying metal components. In such a case, it is not only important that the switch housing is mechanically sealed, but it is also necessary to ensure that the current-carrying components of the switch housing are electrically insulated from each other. If both the lower part and the cover part of the switch housing carry current and serve as the respective electrical terminals of the switch, an electrical short circuit would otherwise occur without such electrical insulation. This can be easily prevented with the help of the aforementioned insulating film.

Typically, the insulating film is clamped between the lower part and the cover part of the switch housing. It thus ensures not only a mechanical seal of the switch housing, but also mutual electrical insulation between the two switch housing components.

The insulating film is typically a few hundredths or tenths of a millimeter thick, and its diameter is adapted to the size of a temperature-dependent switch, so its diameter is typically only a few millimeters or a few centimeters. The insulating film is typically made of a plastics material. In most cases, the insulating film has a through-hole located approximately in the middle, which serves as a clearance for the temperature-dependent switching mechanism. Through this through-hole, the movable contact part can be pressed against the static mating contact in the closed switch state of the switching mechanism.

During the manufacture of temperature-dependent switches, the prefabricated insulating films, cut to the appropriate size and shape, are usually stored in bulk and, during assembly, are generally individually slipped over the switching mechanism by hand or positioned between the two switch housing components before the switch housing is closed.

However, it has been found that during the bulk storage of the pre-cut insulating films, electrical adhesion can occur, for example, due to friction, which can have a negative impact on the assembly process.

Due to such adhesions, it is necessary that the individual insulating films must be singularized or separated from each other in a time-consuming manner before being inserted into the switch housing. If the insulating films overlap precisely, it may even be the case that two such insulating films are accidentally inserted into the switch housing, instead of just one, and this only becomes apparent later, i.e., after the switch has been assembled, due to malfunctions. Even fitters, with their well-trained eyes, make this type of mistake from time to time, resulting in time-consuming and costly follow-up checks for safety reasons.

In the case of fully automated feeding of the insulating films, the overlapping, as well as the precise adhesion of the insulating films, presents a problem insofar as singularization by means of vibrating pot feeding or magazining only inadequately solves the problem. Therefore, similar problems to those already explained above also arise for the manual assembly of the insulating films. As a result, time-consuming and therefore costly follow-up checks are necessary here as well, which is why fully automated insertion of the insulating film during the assembly of the switch has mostly proven to be uneconomical so far, and why a plurality of manual assembly processes still have to be used when assembling such temperature-dependent switches.

### SUMMARY

It is an object to provide an insulating film for the electrical insulation and/or for the mechanical sealing of a temperature-dependent switch, with which the above-mentioned disadvantages can be overcome or at least largely eliminated. It is furthermore an object to prevent the adhesion or overlapping of multiple such insulating films, described above, during bulk material storage, and, furthermore in particular to prevent two adhering insulating films from being mistakenly inserted into one switch during assembly of the temperature-dependent switch.

According to an aspect, an insulating film configured to electrically insulate and/or mechanically seal a temperature-dependent switch is presented, the insulating film being formed of an electrically insulating material and comprising: a through-hole extending from an upper side of the insulating film to a bottom side opposite the upper side; and at least one irregularity element configured to form a local surface irregularity on at least one of the upper side or the bottom side, the at least one irregularity element comprising at least one of a corrugation, a locally roughened region, or a local elevation.

The insulating film is provided with at least one irregularity element that results in a local irregularity on the upper side and/or bottom side of the insulating film. This local irregularity on the otherwise preferably smooth and planar upper side and/or bottom side of the insulating film prevents multiple such insulating films from sticking together during bulk material storage.

The at least one irregularity element, which is preferably designed as a corrugation, local roughening and/or local elevation, acts as a spacer element, so that small gaps are created between the insulating films when they are stacked on top of each other during bulk material storage. The individual insulating films can therefore be separated from each other much more easily.

Due to the at least one irregularity element arranged on the upper side and/or bottom side of the insulating film, the volume increases slightly during bulk material storage. However, the advantage that the individual insulating films can be separated from each other more easily far outweighs this disadvantage. This thus also significantly simplifies the fully automated singularization of the insulating films provided as bulk material. This can virtually eliminate the possibility of accidentally inserting two insulating films instead of just one insulating film into a temperature-dependent switch, whether manually or fully automatically.

In a refinement, the insulating film has multiple regions distributed on the upper side and/or bottom side and separated from each other, in each of which at least one of the at least one irregularity element is arranged. In other words, according to this refinement, the insulating film has multiple such irregularity elements which are distributed across the insulating film in separated regions.

It is preferred to provide these separated regions distributed as evenly spaced, i.e., at equal intervals, on the upper side and/or bottom side of the insulating film. This further improves the aforementioned separation effect of such individual insulating films during bulk material storage.

In a further refinement, the multiple distributed and separated regions are arranged evenly, in particular symmetrically.

Furthermore, it is preferred that the through-hole provided in the insulating film runs along a central center axis and that the insulating film is rotationally symmetric to this center axis.

For example, the insulating film can be designed to be rotationally symmetric about the center axis at 30°, 45°, 60°, 90°, 120° or 180°. The term “rotationally symmetric” here means that the insulating film, when rotated around the center axis by the specified angle, maps itself back onto itself.

Such a rotationally symmetric design of the insulating film has the particular advantage that one degree of freedom, namely the rotation about the center axis of the insulating film, is intentionally left open during assembly. In other words, when installing the insulating film, it is irrelevant in which position the insulating film is rotated, or in which position the center axis is inserted into the switch housing.

In a further refinement, the at least one irregularity element has a first distance from an inner edge of the insulating film that limits the through-hole and a second distance from a radially outer edge of the insulating film, wherein the first distance is less or greater than the second distance, but not the same as the second distance. In other words, according to this refinement, at least one irregularity element is not arranged radially in the middle between the inner edge and the outer edge of the insulating film, but rather is offset either radially outward or radially inward. In particular, it is preferred that the first distance is at least three times greater than the second distance, or that the second distance is at least three times greater than the first distance. In other words, the at least one irregularity element is preferably arranged either close to the inner edge or close to the outer edge of the insulating film.

This has the particular advantage that at least one irregularity element is generally not located at a point on the insulating film which, in the assembled state of the temperature-dependent switch, is clamped between the two housing components of the switch housing. The insulating film is typically clamped between the two housing components of the switch housing with its radially central region, i.e., with its region between the radially inner edge and the radially outer edge of the insulating film. If at least one irregularity element is located at this point or in this region, this could negatively affect the mechanical sealing of the switch. If at least one irregularity element is arranged radially further inward or radially further outward, this usually has no effect on the mechanical sealing of the switch, since the at least one irregularity element is then usually arranged free in the interior of the switch housing or outside of it.

It is understood that in the above-mentioned refinement of the insulating film, which has multiple such irregularity elements, each of these irregularity elements is preferably arranged either closer to the radially inner edge than to the radially outer edge of the insulating film or closer to the radially outer edge than to the radially inner edge of the insulating film, but not at the same distance to the radially inner edge as to the radially outer edge of the insulating film. In such a case, of course, at least one of the multiple irregularity elements can be arranged closer to the radially inner edge than to the radially outer edge, and at least one other of the multiple irregularity elements can be arranged closer to the radially outer edge than to the radially inner edge.

In a further refinement, the insulating film is designed in a ring shape, in particular in a circular shape.

A circular shape for the insulating film is preferred, as it is suitable for insertion into circle-shaped or round switches. However, the shape of the insulating film is not limited to a circular shape. “Ring shape” can also include an oval or elliptical basic shape, as long as the insulating film forms a closed contour (ring shape) around the through-hole.

In a further refinement, at least one irregularity element is incorporated into the insulating film, in particular embossed. In other words, according to this refinement, at least one irregularity element is not subsequently attached as a separate element to the upper side and/or bottom side of the insulating film, but is rather incorporated directly into the insulating film.

The incorporation of at least one irregularity element by embossing is preferred. At least one irregularity element therefore exhibits a kind of embossed indentation. Such embossed indentations are easy and reliable to produce. In particular, it is preferred if such embossed indentations are produced during the punching process for manufacturing the insulating film. The insulating film is typically punched out from a large sheet of film, with the through-hole being punched out simultaneously. If at least one irregularity element is also incorporated into the insulating film simultaneously during this step, no additional step is required.

The embossing and/or incorporation of the at least one irregularity element into the insulating film preferably results in the at least one irregularity element being formed as a local elevation on the upper side of the insulating film and as a local depression on the bottom side.

In a further refinement, at least one irregularity element has a point-shaped elevation.

The at least one irregularity element can therefore be designed, for example, as a point-shaped bump, a point-shaped nipple, a point-shaped bulge or a point-shaped spacer element. The point-shaped or point-like design of the irregularity element is advantageous if multiple such irregularity elements are provided on the insulating film, since such point-shaped irregularity elements, in contrast to elongated struts or large-area irregularity elements, lead to no stiffening of the insulating film, or, if any, only to a negligible stiffening. This simplifies the handling of the insulating film during the assembly of the temperature-dependent switch, as the insulating film typically needs to be bent in multiple points to clamp it into the switch housing or between the two housing components. Therefore, the insulating film must have a certain degree of flexibility.

The insulating film should therefore be designed to be flexible and bendable as a whole.

In a further refinement, the upper side and/or bottom side of the insulating film has a first roughness in the region of the at least one irregularity element, which is greater than a second roughness in the remaining regions of the upper side and/or bottom side of the insulating film.

According to this refinement, the local irregularity or irregularities on the upper side and/or bottom side of the insulating film is/are therefore not formed by individual separate elevations or depressions, but rather by individual regions which create a different local roughness on the upper side and/or bottom side of the insulating film. This can also contribute positively to the effects mentioned above, so that individual insulating films do not tend to stick together too much during bulk material storage.

A similar effect can be achieved through corrugation or the like.

The electrically insulating material of which the insulating film is made is preferably a plastics material, in particular polyimide, most preferably Kapton®.

The material thickness t of the insulating film, measured between the upper side and bottom side, is preferably ≥0.03 mm and ≤0.3 mm. The outer diameter d of the insulating film is preferably ≥5 mm, but ≤30 mm.

According to a further aspect, a temperature-dependent switch is presented, comprising: a first terminal; a second terminal; a temperature-dependent switching mechanism configured to switch in a temperature-dependent manner between a closed switch state, in which an electrically conductive connection is established between the first terminal and the second terminal, and an open switch state, in which the electrically conductive connection is interrupted; and an insulating film configured to electrically insulate and/or mechanically seal the temperature-dependent switch; wherein the insulating film is formed of an electrically insulating material and includes a through-hole extending from an upper side of the insulating film to a bottom side opposite the upper side, and wherein the insulating film further comprises at least one irregularity element configured to form a local surface irregularity on at least one of the upper side or the bottom side, the at least one irregularity element comprising at least one of a corrugation, a locally roughened region, or a local elevation.

In the case of the switch, it is preferred that the switch has a switch housing in which the temperature-dependent switching mechanism is arranged, wherein the switch housing has a lower part and a cover part closing off the lower part, wherein the insulating film is arranged between the lower part and the cover part.

It is preferred that a first portion of the insulating film is clamped between the lower part and the cover part, wherein the at least one irregularity element is spaced apart from this first portion. As mentioned, it is therefore preferred that the at least one irregularity element is arranged at a point on the insulating film which is not clamped between the lower part and the cover part, in order to not negatively affect the mechanical tightness of the switch housing due to the at least one irregularity element.

In a further refinement of the temperature-dependent switch, it is preferred that the temperature-dependent switching mechanism has a static contact and a movable contact part, wherein the temperature-dependent switching mechanism presses the movable contact part through the through-hole of the insulating film against the static contact in the closed switch state, and keeps the movable contact part spaced apart from the static contact in the open switch state. According to this refinement, the through-hole provided in the insulating film thus provides at least one region of the static contact with free access to the movable contact part, so that the temperature-dependent switching mechanism can partially establish the electrical contact between the static contact and the movable contact in the closed switch state.

It is understood that the features mentioned above and those to be explained below can be used not only in the combination specified in each case but also in other combinations or on their own without departing from the spirit and scope of the present disclosure.

### BRIEF DESCRIPTION OF THE DRAWINGS

FIG. 1 shows a first embodiment of an insulating film, in a plan view;

FIG. 2 is a sectional view of the insulating film shown in FIG. 1 according to the first embodiment;

FIG. 3 is a detail of the sectional view shown in FIG. 2;

FIGS. 4a-4d are each plan views of further embodiments of the insulating film;

FIG. 5 is a schematic sectional view of an embodiment of a switch, the switch being in the closed switch state; and

FIG. 6 is a schematic sectional view of the switch shown in FIG. 5, the switch being in the open switch state.

### DESCRIPTION OF PREFERRED EMBODIMENTS

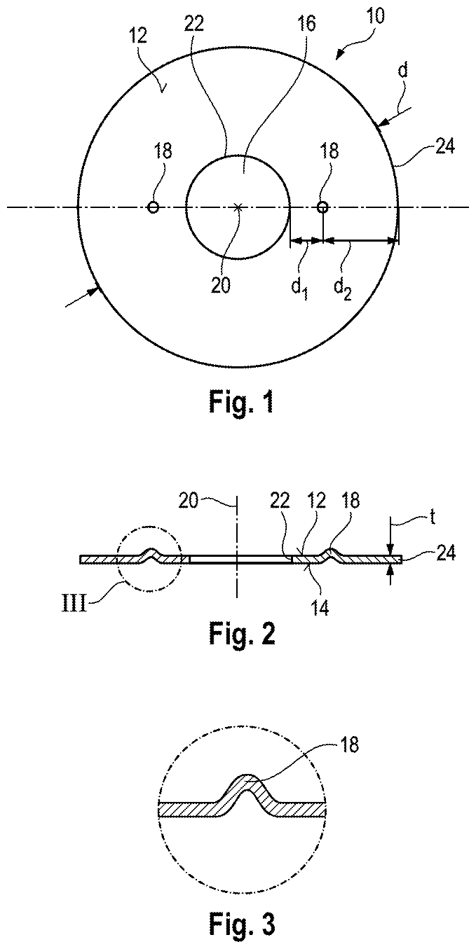

FIGS. 1 and 3 show a first embodiment of the insulating film. Therein, the insulating film is denoted in its entirety by reference sign 10. FIG. 1 shows the insulating film 10 in a plan view. FIG. 2 is a sectional view of the insulating film 10. FIG. 3 shows the detail of the sectional view of the insulating film 10 indicated in FIG. 2 by reference numeral III.

The insulating film 10 is made of a thin film of electrically insulating material. Preferably, the insulating film 10 is made of polyimide, preferably of Kapton®.

The insulating film 10 has a diameter d, which is typically in the range between 5 mm and 30 mm. The material thickness t measured between the upper side 12 and the opposite bottom side 14 of the insulating film 10, which can also be referred to as the thickness of the insulating film 10, is typically in the range between 0.03 mm and 0.3 mm.

In the embodiments shown here, the insulating film 10 is designed in a circular shape in plan view. It has a central through-hole 16, which is preferably arranged in the middle. However, it should be noted that the insulating film 10 does not necessarily have to be circular in shape. Likewise, the through-hole 16 does not necessarily have to be circularly cylindrical. The through-hole 16 as well as the part of the insulating film 10 surrounding this through-hole 16 can also have an oval or elliptical contour. However, it is preferred that the through-hole 16 arranged in the middle is completely surrounded by the insulating film 10; i.e., that the insulating film 10 preferably forms a closed contour surrounding the through-hole 16.

In the first embodiment shown in FIGS. 1-3, the insulating film 10 further has two irregularity elements 18. The irregularity elements 18 are designed here as point-shaped elevations that are molded, preferably embossed, into the insulating film 10. As can be seen in particular from the detail in FIG. 3, the point-shaped elevations each form a local elevation on the upper side 12 of the insulating film 10 and a corresponding local depression on the opposite bottom side 14. It is therefore a kind of dent or indentation that is directly molded into the insulating film 10.

In principle, a single irregularity element 18 can be provided on the insulating film 10. Although it is preferred that the or each irregularity element 18 is molded into the insulating film 10, the or each irregularity element 18 can in principle also be placed on or attached to the insulating film 10 as a separate element, so that the or each irregularity element 18 forms a local elevation on the upper side 12 or the bottom side 14. Likewise, one or more such irregularity elements 18 can be arranged on both the upper side 12 and the bottom side 14 of the insulating film 10.

If, as shown in the first embodiment in FIGS. 1-3, multiple such irregularity elements 18 are provided, these are preferably arranged evenly distributed on the insulating film 10. Preferably, the irregularity elements 18 are arranged such that the insulating film 10 is designed to be rotationally symmetric about a central center axis 20. In the first embodiment shown in FIGS. 1-3, the insulating film 10 is rotationally symmetric about the center axis 20 at 180°.

Furthermore, it is preferred that a distance d₁ from each of the irregularity elements 18 to the inner edge 22 of the insulating film 10 is not equal to a distance d₂ from the irregularity element 18 to the outer edge 24 of the insulating film 10. In other words, it is preferred that each of the irregularity elements 18 is not arranged in the radial center of the insulating film 10, i.e., at the same distance to the inner edge 22 as to the outer edge 24, but instead is arranged offset either radially outward or radially inward. This is intended to prevent the at least one irregularity element 18 from being clamped between the two switch housing components of the switch in the assembled state and thus potentially leading to leaks. As can be seen from FIG. 1, the irregularity elements 18 are arranged closer to the inner edge 22 than to the outer edge 24 (d₁ <d₂).

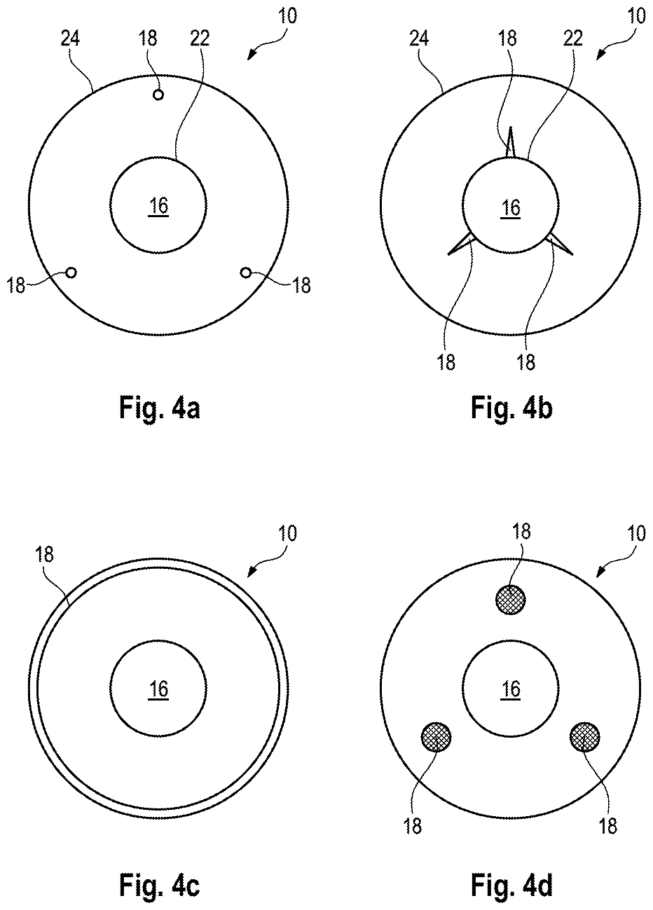

FIG. 4a shows another embodiment of the insulating film 10, in which the irregularity elements 18 are again designed as point-shaped elevations on the upper side 12, which are molded into the insulating film 10. However, a total of three such point-shaped elevations are provided here, which form the irregularity elements 18. The insulating film 10 is therefore rotationally symmetric about the central center axis 20 by 120°. The irregularity elements 18 are furthermore arranged closer to the outer edge of the insulating film 10 than to the inner edge 22 of the insulating film 10 (d₂ <d₁).

In the third embodiment shown in FIG. 4b, the insulating film 10 also has three irregularity elements 18 and is designed to be rotationally symmetric by 120°. The irregularity elements 18 each border directly on the inner edge 22. Unlike in FIG. 4a, the irregularity elements 18 in the third embodiment shown schematically in FIG. 4b are not designed as point-shaped elevations, but as line-or arrow-shaped, elongated struts. These elongated or arrow-shaped struts are also preferably molded into the insulating film 10 and lead to local elevations on the upper side 12 of the insulating film 10.

FIG. 4c shows a fourth embodiment of the insulating film 10. In this fourth embodiment, the insulating film 10 has only a single irregularity element 18. The irregularity element 18 is designed here in a linear or circle shape. It forms a closed contour that completely surrounds the through-hole 16. This linear or circle-shaped strut is preferably also molded in the insulating film 10 and can have the same cross-sectional shape as shown in FIG. 3 for the point-shaped elevation according to the first embodiment.

FIG. 4d shows a fifth embodiment of the insulating film 10. Here, the insulating film 10 again has three irregularity elements 18. The irregularity elements 18 are each designed as round regions in which the insulating film 10 has a greater roughness than in the other regions of the upper side 12 and the bottom side 14 of the insulating film 10. For example, the insulating film 10 may be locally corrugated or roughened in these regions.

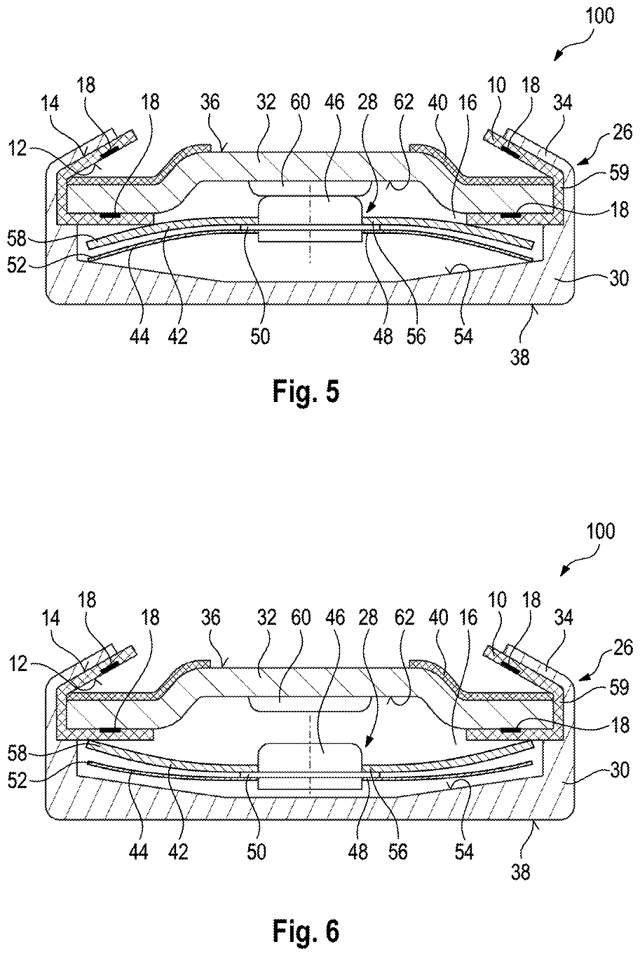

FIGS. 5 and 6 show an embodiment of a temperature-dependent switch. The switch is denoted in its entirety by reference sign 100.

FIG. 5 shows the closed position of the switch 100. FIG. 6 shows the open position of the switch 100.

Of course, the switch 100 shown in FIGS. 5 and 6 is only one example of a variety of possible embodiments of such a temperature-dependent switch in which the insulating film 10 can be incorporated. In particular, the switching mechanism and the housing of the switch 100 can, in principle, be constructed differently than shown here in FIGS. 5 and 6.

The switch 100 shown in FIGS. 5 and 6 has a switch housing 26, in the interior of which a temperature-dependent switching mechanism 28 is arranged. The switch housing 26 comprises a pot-shaped lower part 30 and a cover part 32, which closes off the lower part 30. More precisely, the cover part 30 is held to the lower part 30 by a bent or crimped upper edge 34.

In the embodiment of the switch 100 shown in FIGS. 5 and 6, both the lower part 30 and the cover part 32 are made of an electrically conductive material, preferably metal. The insulating film 10 is arranged between the lower part 30 and the cover part 32. The insulating film 10 ensures electrical insulation of the lower part 30 from the cover part 32. Likewise, the insulating film 10 ensures a mechanical seal that prevents liquids or contamination from entering the interior of the switch housing 26 from the outside.

The points where the irregularity elements 18 are arranged on the insulating film 10 are shown schematically in FIGS. 5 and 6. However, as can be seen, it is preferred that the points where the irregularity elements 18 are arranged on the insulating film 10 are arranged either radially as far inward as possible or radially as far outward as possible, so as not to be clamped between the cover part 32 and the lower part 30.

It also becomes clear why the insulating film 10 has the centrally arranged through-hole 16. At least in the closed switch state shown in FIG. 5, the temperature-dependent switching mechanism 28 protrudes through the through-hole 16 in order to establish the electrical contact in the closed switch state between the current-carrying lower part 30 and the current-carrying cover part 32.

Since the lower part 30 and the cover part 32 are each made of electrically conductive material in this embodiment, the outer surfaces of the lower part 30 and the cover part 32 can serve for the electrical terminal of the switch 100. For example, the outer surface of the cover part 32 can function as the first terminal 36 and the outer surface of the lower part 30 as the second terminal 38 of the switch 100. For example, a connecting lead can be soldered or welded to each of these terminals 36, 38, which serve for the electrical connection of the switch 100.

In the embodiment shown here, a further insulating layer 40 is arranged on the outside of the cover part 32.

The switching mechanism 28 is arranged clamped between the lower part 30 and the cover part 32. The switching mechanism 28 has a bimetal element 42, a spring element 44, and a movable contact part 46. The bimetal element 42 comprises a temperature-dependent bimetal disc with a central opening provided therein, by which the bimetal disc is slipped over the movable contact part 46.

The spring element 44 comprises a temperature-independent spring snap disc, which, with a central opening provided therein, is also slipped over the movable contact part 46, but from an opposite bottom side.

In the closed position of the switch 100 shown in FIG. 5, the spring element 44 supports the movable contact part 46 from below by pressing its inner edge region 48 from below against a circumferential, circular-shaped collar 50 of the movable contact part 46. In this case, the spring element 44 rests with its outer, circumferential edge 52 on the inner base 54 of the lower part 30.

In this position of the switch 100, the bimetal element 42 preferably rests freely with its inner edge region 56 on the collar 50 of the movable contact part 46, from the opposite upper side. The outer, circumferential edge 58 of the bimetal element 42 hangs freely into the interior of the switch housing 26. For this type of switch 100, the bimetal element 42 is thus mounted in the switch housing 26, in the closed position, with virtually no force without being firmly clamped therein.

In the low temperature position of the switch 100 shown in FIG. 5, the temperature-dependent switching mechanism 28 establishes an electrically conductive connection between the two electrical terminals 36, 38 of the switch 100 by virtue of the movable contact part 46 being pressed against the stationary and/or static contact 60 arranged on the cover 32. The contact pressure with which the movable contact part 46 is pressed against the static contact 60 in the closed position of the switch 100 is caused by the spring element 42 in the switch 100. The spring element 42 pushes the movable contact part 46 through the through-hole 16 in the insulating film 10 against the static contact 60.

If the temperature of the device to be protected, and thus the temperature of the switch 100 and the bimetal element 42 arranged therein, then increases, starting from the closed position of the switch 100 shown in FIG. 5, to or above the response temperature of the bimetal element 42, then the bimetal element 42 snaps from its convex low-temperature configuration shown in FIG. 5 to its concave high-temperature configuration shown in FIG. 6. During this snapping action, the bimetal element 42 rests with its outer edge 58 against the bottom side 62 of the cover part 32 with the insulating film 10 in between. With its center or inner edge region 56, the bimetal element 42 pushes the movable contact part 46 downward and lifts the movable contact part 46 away from the static contact 60. As a result, the spring element 44 simultaneously bends downward at its center, so that the spring element 44 snaps from its first geometric configuration shown in FIG. 5 into its second geometric configuration shown in FIG. 6. The electrically conductive connection, previously established via the switching mechanism 28, between the two external terminals 36, 38 of the switch 100 is thus interrupted.

The temperature-dependent switching mechanism 28 of the switch 100 is thus configured to establish and disconnect the electrically conductive connection between the two external terminals 36, 38 according to the temperature. In one embodiment of the switch 100, which is referred to as “normally closed,” the switching mechanism 28 is located, below the response temperature of the bimetal element 42, in the closed position shown in FIG. 5, in which it establishes the electrically conductive connection between the two terminals 36, 38. Above the response temperature of the bimetal element 42, the temperature-dependent switching mechanism 28 is in its open position as shown in FIG. 6.

In principle, however, this can also be designed in reverse, so that the temperature-dependent switching mechanism 28 is located, below the response temperature of the bimetal element 42, in the open position shown in FIG. 6, and above the response temperature of the bimetal element 42 is in the closed position shown in FIG. 5. This is then referred to as “normally open.”

Furthermore, it is to be understood that the foregoing is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “e.g.,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. An insulating film configured to electrically insulate and/or mechanically seal a temperature-dependent switch, the insulating film being formed of an electrically insulating material and comprising:
a through-hole extending from an upper side of the insulating film to a bottom side opposite the upper side; and
at least one irregularity element configured to form a local surface irregularity on at least one of the upper side or the bottom side, the at least one irregularity element comprising at least one of a corrugation, a locally roughened region, or a local elevation.

2. The insulating film of claim 1, wherein the insulating film includes a plurality of regions distributed over at least one of the upper side or the bottom side and spaced apart from one another, each of the plurality of regions including at least one irregularity element of the insulating film.

3. The insulating film of claim 2, wherein the plurality of regions are evenly distributed and arranged symmetrically.

4. The insulating film of claim 1, wherein the through-hole extends along a center axis and the insulating film is rotationally symmetric about the center axis.

5. The insulating film of claim 1, wherein the at least one irregularity element is positioned at a first distance from an inner edge of the insulating film defining the through-hole and at a second distance from a radially outer edge of the insulating film, the first distance being different from the second distance.

6. The insulating film of claim 1, wherein the insulating film has an annular shape.

7. The insulating film of claim 6, wherein the annular shape is circular in plan view.

8. The insulating film of claim 1, wherein the at least one irregularity element is embossed in the insulating film.

9. The insulating film of claim 1, wherein the at least one irregularity element comprises a point-like elevation.

10. The insulating film of claim 1, wherein at least one of the upper side or the bottom side of the insulating film has a first roughness in a region of the at least one irregularity element, the first roughness being greater than a second roughness of other regions of the insulating film.

11. The insulating film of claim 1, wherein the electrically insulating material comprises polyimide.

12. The insulating film of claim 1, wherein the insulating film has a thickness of from 0.03 mm to 0.3 mm and an outer diameter of from 5 mm to 30 mm.

13. The insulating film of claim 1, wherein the insulating film comprises a plurality of irregularity elements.

14. The insulating film of claim 13, wherein the plurality of irregularity elements are evenly distributed over the insulating film.

15. The insulating film of claim 1, wherein the at least one irregularity element forms a local elevation on the upper side and a corresponding local depression on the bottom side.

16. The insulating film of claim 1, wherein the at least one irregularity element is elongated or annular.

17. A temperature-dependent switch, comprising:
a first terminal;
a second terminal;
a temperature-dependent switching mechanism configured to switch in a temperature-dependent manner between a closed switch state, in which an electrically conductive connection is established between the first terminal and the second terminal, and an open switch state, in which the electrically conductive connection is interrupted; and
an insulating film configured to electrically insulate and/or mechanically seal the temperature-dependent switch;
wherein the insulating film is formed of an electrically insulating material and includes a through-hole extending from an upper side of the insulating film to a bottom side opposite the upper side, and
the insulating film further comprises at least one irregularity element configured to form a local surface irregularity on at least one of the upper side or the bottom side, the at least one irregularity element comprising at least one of a corrugation, a locally roughened region, or a local elevation.

18. The temperature-dependent switch of claim 17, further comprising a switch housing in which the temperature-dependent switching mechanism is arranged, the switch housing including a lower part and a cover part closing the lower part, wherein the insulating film is arranged between the lower part and the cover part.

19. The temperature-dependent switch of claim 18, wherein the insulating film is clamped between the lower part and the cover part, and wherein the at least one irregularity element is positioned outside a region of the insulating film clamped between the lower part and the cover part.

20. The temperature-dependent switch of claim 17, wherein the temperature-dependent switching mechanism comprises a static contact and a movable contact part, the temperature-dependent switching mechanism being configured to press the movable contact part through the through-hole of the insulating film against the static contact in the closed switch state and to maintain the movable contact part spaced apart from the static contact in the open switch state.
